(19) United States
(12) Patent Application Publication
(10) Pub. No.: US 2018/0022322 A1
(43) Pub. Date: Jan. 25, 2018

(54) WINDSHIELD WIPER DEVICE

(71) Applicant: Robert Bosch GmbH, Stuttgart (DE)

(72) Inventor: Stefan Baumert, Karlsruhe (DE)

(21) Appl. No.: 15/536,196

(22) PCT Filed: Nov. 11, 2015
(86) PCT No.: PCT/EP2015/076331

§ 371 Date: Jun. 15, 2017

(30) Foreign Application Priority Data
Dec. 18, 2014 (DE) 10 2014 226 365.4

(51) Int. Cl. B60S 1/38; B60S 1/04

(52) U.S. Cl. CPC B60S 1/3808; B60S 1/0408; B60S 2001/3812

(57) ABSTRACT

The invention relates to a windshield wiper device (100, 200, 300) for a vehicle, in particular a motor vehicle, comprising a wiper blade (2) having an elongate upper part (10), which is at least partially flexible, an elongate lower part (12), which is at least partially flexible, a plurality of connecting elements (18) for connecting the upper part (10) and the lower part (12), wherein the connecting elements (18) are spaced apart from each other along a longitudinal extent (8) of the wiper blade (2) and are attached to the upper part (10) and/or to the lower part (12) by means of a rotary joint, in particular wherein the connecting elements (18) are designed to enable a motion of the upper part (10) and of the lower part (12) relative to each other having a motion component along the longitudinal extent (8) of the wiper blade (2), and a spoiler (110, 210, 310, 410), which is arranged on the elongate upper part (10).

### BACKGROUND OF THE INVENTION

The disclosure relates to a windshield wiper device for a vehicle, in particular a motor vehicle, to an adapter device for connecting the windshield wiper device to the vehicle, and to a method for producing a windshield wiper device.

Windshield wiper devices typically have a wiper arm, wherein a wiper blade, to which a wiper lip is fastened, is moved over the windshield of a motor vehicle. The wiper arm is moved alternately between a first turning position and a second turning position. For this purpose, the wiper arm is connected to a wiper motor via the driveshaft. In particular when the vehicle is in motion, the wiper blade can lose contact with the windshield slightly on account of the relative wind. This can result in unwiped wiping areas or the formation of streaks.

Furthermore, the wiper blade should exert a uniform and sufficient contact pressure (bearing force) on the windshield of the vehicle along its length in order to allow a good wiping effect and to reduce or avoid the formation of streaks. The contact pressure exerted on the windshield can vary, however, in particular on account of the relative wind, with the result that a wiping effect is impaired and the formation of streaks can occur.

Therefore, there is a need to further improve windshield wiper devices in order to ensure contact of the windshield wiper device with the windshield of the vehicle even in the presence of relative wind. In particular, there is a need to further improve windshield wiper devices in order to ensure a sufficient contact pressure of the wiper blade on the windshield.

In the improvement of wiper blade devices, there are a plurality of boundary conditions that should be taken into account. These include the manufacturing expense or production costs, the material costs, but also the properties of the windshield wiper device, in particular the function under a wide variety of conditions and the durability under a large number of conditions. In this case, in the case of wiper devices for vehicles, account should be taken of the continuous increase in the cost pressure and of the fact that the vehicles can be used in a large number of climatic conditions, and so for example extreme temperature values arise in an enduring manner and/or with large fluctuations.

### SUMMARY OF THE INVENTION

The object of the present disclosure is to provide a windshield wiper device with which at least one or more of the abovementioned drawbacks are reduced or do not substantially arise.

According to embodiments of the present disclosure, a windshield wiper device for a vehicle, in particular a motor vehicle, is specified, comprising a wiper blade. The wiper blade comprises an elongate upper part which is configured in an at least partially flexible manner, an elongate lower part which is configured in an at least partially flexible manner, a plurality of connecting elements for connecting the upper part and the lower part, wherein the connecting elements are spaced apart from one another along an elongate extent of the wiper blade and are attached to the upper part and/or to the lower part by means of a rotary joint, in particular wherein the connecting elements are designed to allow a movement of the upper part and of the lower part relative to one another with a movement component along the longitudinal extent of the wiper blade, and a spoiler which is arranged on the elongate upper part.

The windshield wiper device according to the present disclosure can ensure contact of the wiper blade, and in particular of the wiper lip, with the windshield of the vehicle even in the presence of relative wind. In particular, the windshield wiper device according to the present disclosure can ensure a sufficient contact pressure of the wiper blade on the windshield. Thus, a wiping effect can be improved and formation of streaks prevented.

Preferred, optional embodiments and particular aspects of the disclosure can be gathered from the dependent claims, the drawings and the present description.

According to the embodiments described herein, wiper blades for windshield wiper devices, in particular wiper blades for fin ray windshield wiper devices for vehicle windshields, can be produced in a particularly economical manner and/or for a plurality of different fields of use. The present embodiments of the fin ray windshield wiper device allow, in particular on account of the spoiler, a uniform and sufficient contact pressure on the windshield even in the presence of relative wind. This ensures particularly good and exact wiping of the windshield. Unwiped areas of the windshield and formation of streaks on the windshield can be largely avoided.

According to embodiments of the disclosure, the spoiler has a cross section substantially perpendicular to the longitudinal extent of the wiper blade, wherein the cross section is symmetric or asymmetric. As a result of the symmetric or asymmetric cross section, the spoiler can provide an optimal bearing behavior on the windshield, taking for example a wind direction of the relative wind, the curvature of the windshield and/or a wiping direction of the windshield wiper device into account.

In some embodiments, the spoiler has a cross section substantially perpendicular to the longitudinal extent, wherein the cross section changes along the longitudinal extent. As a result of the changing cross section, the spoiler can be designed to locally provide an optimal contact pressure on the windshield.

Typically, the spoiler extends along at least a part of a length of the wiper blade in the longitudinal extent, in particular along at least 50%, along at least 80% or along 100%. As a result of the extent along at least a substantial part of the longitudinal extent of the wiper blade, the spoiler can achieve a maximum effect.

According to some embodiments, the spoiler has two or more segments which are arranged on the upper part, i.e. mounted thereon or fastened thereto, such that the spoiler is flexible for example with regard to the longitudinal extent. In some embodiments, the two or more segments are arranged in a manner spaced apart from one another. As a result, the spoiler can be flexible, such that the wiper blade can adapt to the curvature of the windshield of the vehicle.

Typically, the spoiler is formed from hard plastic, in particular from thermoplastic or thermosetting plastic. As a result, the spoiler can be produced easily and stably.

According to embodiments, at least the upper part and the spoiler are formed in one piece or integrally. As a result, the spoiler and the upper part can be produced easily with reduced effort, for example by an injection-molding process.

In some embodiments, the windshield wiper device has a wiper-blade-side fastening part which is designed to be connected to a fastening element on the vehicle. According to embodiments, the windshield wiper device comprises an adapter device which is configured as an interface between the wiper-blade-side fastening part and the fastening element on the vehicle. As a result, the windshield wiper device can be mounted easily on differently configured fastening elements, since, in particular, only different adapter devices have to be provided. It is not necessary to adapt the entire windshield wiper device, and in particular the wiper blade, to differently configured fastening elements.

According to one aspect of the present disclosure, an adapter device is specified which is configured as an adapter or interface between the wiper-blade-side fastening part of the windshield wiper device and the fastening element on the vehicle. The adapter device is designed to be connected to the wiper-blade-side fastening part of the windshield wiper device and to the fastening element on the vehicle. As a result, the windshield wiper device can be mounted easily on differently configured fastening elements.

According to a further aspect of the present disclosure, a method for producing an above-described windshield wiper device is specified, comprising formation of the spoiler on the upper part by means of injection-molding. As a result, the spoiler can be produced easily and stably. In particular, the spoiler and the upper part can be produced easily with reduced effort.

### BRIEF DESCRIPTION OF THE DRAWINGS

Exemplary embodiments of the disclosure are illustrated in the figures and described in more detail in the following text. In the figures:

FIG. 1 shows a schematic illustration of a windshield wiper device according to embodiments of the present disclosure,

FIG. 2 shows a schematic illustration of a windshield wiper device according to further embodiments of the present disclosure,

FIG. 3A shows a schematic illustration of a windshield wiper device having a wiper blade according to embodiments of the disclosure in a basic position,

FIG. 3B shows a schematic illustration of the windshield wiper device according to embodiments of the disclosure according to FIG. 3A in a position placed against a windshield,

FIG. 4A shows a schematic illustration of a windshield wiper device having a wiper blade according to further embodiments of the disclosure in a basic position,

FIG. 4B shows a schematic illustration of the windshield wiper device according to embodiments of the disclosure according to FIG. 4A in a position placed against a windshield,

FIG. 5A shows a schematic illustration of a windshield wiper device according to other embodiments of the disclosure, and

FIG. 5B shows a schematic illustration of an adapter device of the windshield wiper device according to embodiments of the disclosure.

### DETAILED DESCRIPTION

In the following text, unless noted otherwise, the same reference signs are used for identical elements and elements having the same effect.

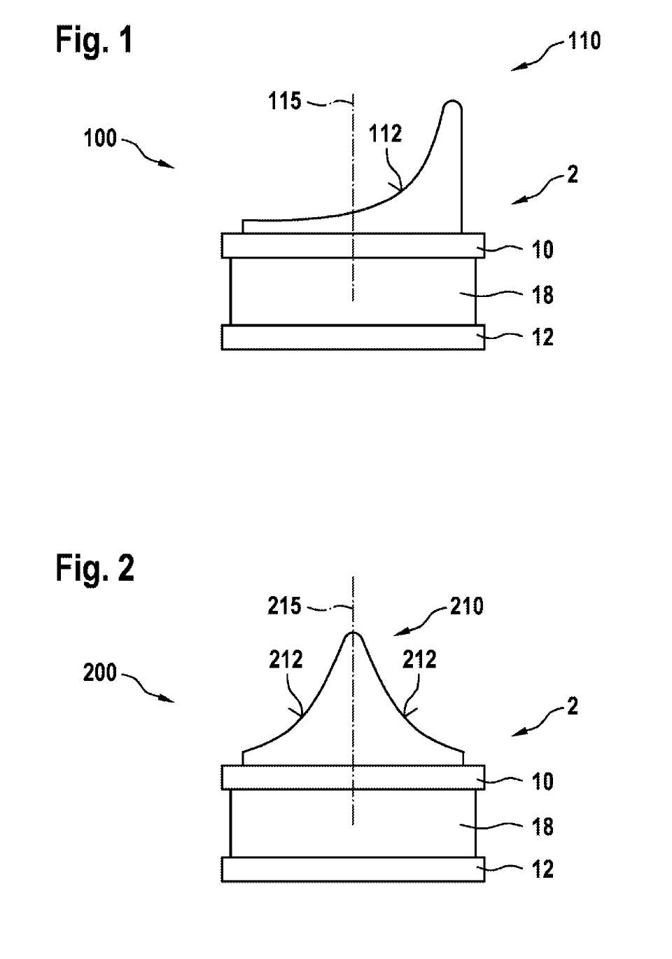

FIG. 1 shows a schematic illustration of a windshield wiper device 100 according to embodiments of the present disclosure.

According to embodiments of the present disclosure, the windshield wiper device 100 is suitable for a vehicle, in particular a motor vehicle. The windshield wiper device 100 comprises a wiper blade 2. The wiper blade 2 comprises an elongate upper part 10 which is configured in an at least partially flexible manner, an elongate lower part 12 which is configured in an at least partially flexible manner, a plurality of connecting elements 18 for connecting the upper part 10 and the lower part 12, wherein the connecting elements 18 are spaced apart from one another along a longitudinal extent of the wiper blade 2 and are attached to the upper part 10 and/or to the lower part 12 by means of a rotary joint, in particular wherein the connecting elements 18 are designed to allow a movement of the upper part 10 and of the lower part 12 relative to one another with a movement component along the longitudinal extent of the wiper blade 2. In this case, the connecting elements 18 are connected to the upper part 10 at a respective upper connecting position and to the lower part 12 at a respective lower connecting position. For example, a rotary joint is provided at each of the connecting positions. In the event of a movement of the upper part 10 and of the lower part 12 relative to one another, the spacing of an upper connecting position from a lower connecting position at the same connecting element 18 does not substantially change, i.e. the spacing is constant with deviations of for example ±1 mm, in particular ±0.3 mm.

The wiper blade 2 furthermore comprises a spoiler 110, which is arranged on the elongate upper part 10. According to embodiments, the spoiler 110 can also be known as a “wind deflection device”.

According to embodiments, the wiper blade 2 comprises a wiper lip (not shown) which is arranged on the lower part 12 of the wiper blade 2. The wiper lip is typically located on the underside, facing away from the upper part 10, of the lower part 12. The wiper lip can be designed to be placed on the windshield of the vehicle for the purposes of wiping. For reasons of clarity, the wiper lip is not illustrated in the figures.

The windshield wiper device 100 according to the present disclosure can ensure that the wiper blade 2, and in particular the wiper lip, is in contact with the windshield of the vehicle even in the presence of relative wind. In particular, the windshield wiper device 100 according to the present disclosure can ensure a sufficient contact pressure of the wiper blade 2 on the windshield. In this way, a wiping effect can be improved, and the formation of streaks and relative-wind-related wiping errors can be prevented.

According to embodiments of the disclosure, the spoiler 110 has a cross section substantially perpendicular to the longitudinal extent, wherein the cross section can be asymmetric. The spoiler 110 can be asymmetric with respect to an axis 115. In this case, the axis 115 can be substantially perpendicular to the longitudinal extent of the wiper blade 2. On account of the asymmetric cross section, the spoiler 110 can provide an optimal contact pressure on the windshield, taking for example a wind direction of the relative wind, the curvature of the windshield, and/or a wiping direction of the windshield wiper device 100 into account. According to embodiments, the windshield wiper device 100 with the asymmetric spoiler can be used in left-hand-drive vehicles.

The spoiler 110 typically has an incident flow surface 112. The incident flow surface 112 can be grooved or concave. The incident flow surface 112 can be designed such that, during operation of the wiper blade 2, it faces the main direction of flow of the relative wind prevailing at the windshield. The spoiler 110 can thus improve bearing behavior of the wiper blade 2, in particular at high traveling speeds.

In some embodiments, which can be combined with other embodiments described herein, the spoiler 110 has a cross section substantially perpendicular to the longitudinal extent, wherein the cross section changes along the longitudinal extent. On account of the changing cross section, the spoiler 110 can be designed to locally provide an optimal contact pressure on the windshield. For example, a shape or design of the incident flow surface 112 can change along the longitudinal extent, such that the bearing behavior or the contact pressure of the wiper blade 2 on the windshield of the vehicle can be set or adjusted locally.

According to some embodiments, which can be combined with other embodiments, the spoiler 110 extends along at least some of a length of the wiper blade 2 in the longitudinal extent, in particular along at least 50%, along at least 80% or along 100%, i.e. substantially along the entire length of the wiper blade 2. As a result of the extension along at least a substantial part of the longitudinal extent of the wiper blade 2, the spoiler 110 can achieve a maximum effect.

Typically, the spoiler 110 is formed from hard plastic, in particular from thermoplastic or thermosetting plastic. The spoiler 110 and/or the upper part 10 can be formed for example by extrusion. As a result, the spoiler 110 can be produced easily and stably. According to embodiments, at least the upper part 10 and the spoiler 110 are formed in one piece or integrally. As a result, the spoiler 110 and the upper part 10 can be produced easily with reduced effort.

FIG. 2 shows a schematic illustration of a windshield wiper device 200 according to embodiments of the present disclosure.

According to embodiments of the disclosure, the spoiler 210 has a cross section substantially perpendicular to the longitudinal extent, wherein the cross section is symmetric. The spoiler 210 can be symmetric with respect to an axis 215. In this case, the axis 215 can be substantially perpendicular to the longitudinal extent of the wiper blade 2. On account of the symmetric cross section, the spoiler 210 can provide an optimal contact pressure on the windshield, taking for example a wind direction of the relative wind, the curvature of the windshield and/or a wiping direction of the windshield wiper device 200 into account. According to embodiments, the windshield wiper device 200 with the symmetric spoiler can be used in left-hand-drive or right-hand-drive vehicles.

The spoiler 210 typically has one or more incident flow surfaces 212 and can have in particular two incident flow surfaces 212 which are arranged symmetrically about the axis 215. The incident flow surfaces 212 can be grooved or concave. The incident flow surfaces 212 can be designed such that, during operation of the wiper blade 2, they alternately face the main direction of flow of the relative wind prevailing at the windshield. Thus, the spoiler 110 can improve a bearing behavior of the wiper blade 2 in particular at high traveling speeds.

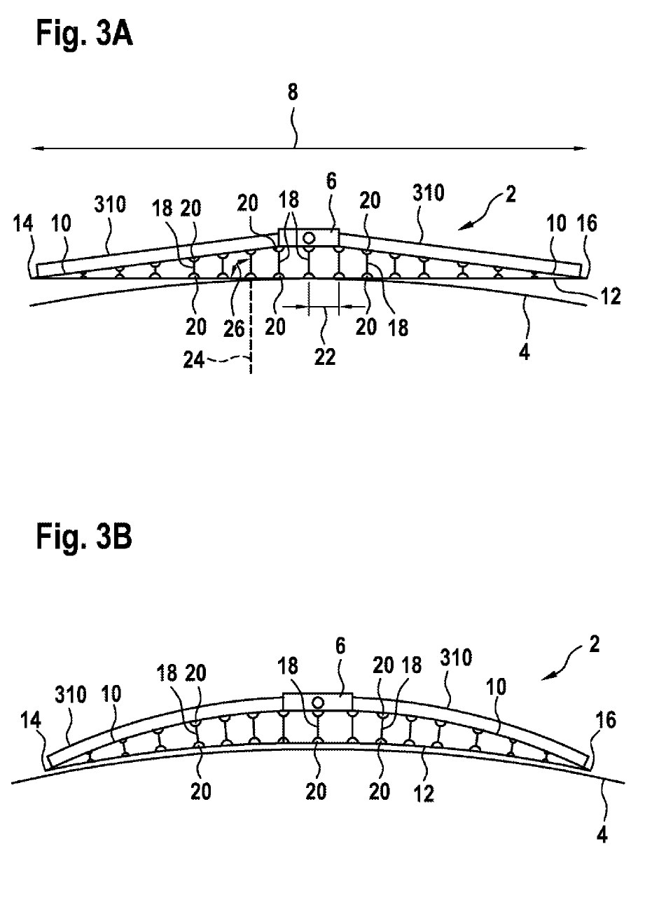

FIG. 3A shows a schematic illustration of a windshield wiper device with the wiper blade 2 according to embodiments of the disclosure in a basic position. FIG. 3B shows a schematic illustration of the windshield wiper device according to embodiments of the disclosure according to FIG. 3A in a position placed against a windshield 4.

FIGS. 3A and 3B show the wiper blade 2 with the longitudinal extent 8 which extends substantially between connecting positions 14 and 16. Such an arrangement is frequently used for front windshield wipers. According to embodiments, the windshield wiper device can be a front windshield wiper device or a front windshield wiper.

FIGS. 3A and 3B show schematic illustrations of a wiper blade 2 in a basic position (FIG. 3A) and in a position placed against the windshield 4 (FIG. 3B) according to embodiments of the windshield wiper device of the disclosure. The wiper blade 2 serves to wipe the windshield 4 of the vehicle, which is for example a motor vehicle, in particular a car. Usually, the wiper blade 2 is attached to a windshield wiper arm, which is driven by means of a motor for the purposes of wiping. To this end, the wiper blade 2 has a holder 6 by way of which it can be fastened to the windshield wiper arm. In FIG. 3A, the wiper blade 2 is in a basic position, in which it is at least partially lifted off the windshield 4. The wiper blade 2 has the longitudinal extent 8 and has the elongate upper part 10 and the likewise elongate lower part 12. The longitudinal extents of the upper part 10 and of the lower part 12 correspond substantially to the longitudinal extent 8 of the wiper blade 2.

Both the upper part 10 and the lower part 12 are flexible bars or can be configured as flexible bars which are each formed in one piece by way of example in FIGS. 3A and 3B. This allows a particularly stable construction. It is likewise possible to configure only in each case some of the upper part 10 and/or of the lower part 12 to be flexible. Furthermore, it is alternatively possible to configure the upper part 10 in two parts, wherein in each case one end of the two parts of the two-part upper part 10 is then fastened to the holder 6.

According to some embodiments, which can be combined with the other embodiments described herein, a material is used for the upper part 10 and/or the lower part 12 which has a modulus of elasticity in a range between 0.005 kN/mm² and 0.5 kN/mm², in particular 0.01 kN/mm² and 0.1 kN/mm². This allows suitable flexibility of the upper part 10 and of the lower part 12. Together with a suitably configured cross-sectional area of the upper part 10 and of the lower part 12, this results in optimal flexural rigidity. The upper part 10 and the lower part 12 are arranged such that they are located opposite one another. Both ends of the upper part 10 are firmly connected to in each case one end of the lower part 12 at outer connecting positions 14 and 16. Otherwise, the upper part 10 and the lower part 12 are spaced apart from one another.

The windshield wiper device has the spoiler 310, which is arranged on the upper part 10. The spoiler 310 can be configured in accordance with the embodiments described herein. In particular, the spoiler 310 can be configured in a symmetric or asymmetric manner with respect to an axis, as is shown in the example in FIGS. 1 and 2.

The upper part 10 and the lower part 12 are connected together by the connecting elements 18. In particular in the basic position of the wiper blade 2, these extend approximately transversely to the longitudinal extent 8 of the wiper blade 2. The connecting elements 18 are fastened by means of rotary joints 20 at mutually facing inner longitudinal sides of the upper part 10 and of the lower part 12. The rotary joints 20 are for example hinges in this case. In particular, the rotary joints 20 can be in the form of film hinges. This is advantageous especially when the upper part 10, lower part 12 and/or connecting elements 18 are produced from a plastic material or are coated with a suitable plastic material.

According to typical embodiments described herein, which can be combined with other embodiments described herein, a rotary joint is selected from the following group, which consists of: a hinge, a film hinge, a narrowing of the material in order to create reduced stiffness along a torsion axis, a joint with an axis of rotation, a means for connecting the upper part 10 to the connecting element 18 or for connecting the lower part 12 to the connecting element 18, which allows the lower part 12 to be displaced along the longitudinal extent 8 with respect to the upper part 10, etc.

Embodiments in which the joint is provided by a film hinge provide a very simple way of providing the joints for a fin ray wiper. According to typical embodiments, the film hinges have high elasticity. This can be provided for example by a material selected from the group PP, PE, POM and PA. Alternatively, the film hinges can be produced from one or more materials from the group consisting of: TPE (thermoplastic elastomer), for example TPE-S, TPE-O, TPE-U, TPE-A, TPE-V and TPE-E.

The connecting elements 18 are spaced apart from one another along the longitudinal extent of the wiper blade 2. The spacings between in each case two adjacent connecting elements 18 are the same. However, they can also be selected to be different. The spacings are advantageously less than 50 mm, in particular less than 30 mm. As a result, particularly high flexibility of the windshield wiper device, in particular of the lower part 12 thereof, and good adaptation to the curvature and changes in curvature of the windshield 4 to be wiped can be ensured. A spacing 22 that represents the spacings between in each case two connecting elements 18 is illustrated in FIG. 3A. The connecting elements 18 are, in particular in the basic position of the wiper blade 2, fastened to the lower part 12 such that their longitudinal axes extend at angles 26 to the lower part 12.

In FIG. 3A, a longitudinal axis 24 is illustrated by way of example for the longitudinal axes of the connecting elements 18, and an angle 26 is illustrated by way of example for the angles between the connecting elements 18 and the lower part 12. The spacings between the upper part 10 and the lower part 12 are primarily determined by the lengths of the connecting elements 18. Starting from the two outer connecting positions 14, 16 approximately as far as those points at which the holder 6 attached to the upper part 10 begins, the lengths of the connecting elements 18 increase. As a result, the upper part 10 and lower part 12 form a double wedge in the side view of the wiper blade 2 according to FIG. 3A, wherein the tips of the two wedges point in opposite directions. The connecting elements 18 are embodied so as to be resistant to buckling.

The connecting elements 18 are connected to the upper part 10 at a respective upper connecting position and to the lower part 12 at a respective lower connecting position. For example, a rotary joint is provided at each of the connecting positions. In the event of a movement of the upper part 10 and of the lower part 12 relative to one another, the spacing of an upper connecting position to a lower connecting position at the same connecting element 18 does not substantially change, i.e. the spacing is constant with deviations of for example ±1 mm, in particular ±0.3 mm.

FIG. 3B shows a schematic illustration of the wiper blade 2 according to FIG. 3A in a position placed against the windshield 4. Since the windshield 4 has a curvature, when the wiper blade 2 is placed against the windshield 4, contact pressure forces act on the lower part 12. Since the upper part 10 having the spoiler 310 and the lower part 12 are flexible beams and the connecting elements 18 are mounted in a rotatable manner on the upper part 10 and lower part 12, the upper part 10 and the lower part 12 are displaceable with respect to one another. As a result of the pressure forces acting on the lower part 12 from below, the wiper blade 2 bends in that direction from which the pressure forces come, and is placed precisely against the curvature of the windshield 4.

In the illustration according to FIG. 3B, a small gap is present between the wiper blade 2 and the windshield 4, this gap serving in this case only to make the windshield 4 and the wiper blade 2 clear and in fact largely not being present when the wiper blade 2 is placed against the windshield 4. Furthermore, a wiper lip is typically located on the underside, facing away from the upper part 10, of the lower part 12, said wiper lip being placed on the windshield 4 for the purposes of wiping. For reasons of clarity, the wiper lip is not illustrated in FIGS. 3A and 3B.

A windshield wiper device according to embodiments described herein uses the effect of tailfins of particular fish which, upon lateral pressure, do not yield in the direction of pressure but bulge in the opposite direction, i.e. in the direction from which the pressure comes. This principle is also known as the fin ray principle. As a result, a windshield wiper device according to the embodiments described herein has the advantage of adapting better to a windshield of a motor vehicle. In a conventional windshield wiper blade, the upper part thereof is usually rigid, i.e. it is not configured to be flexible.

In FIG. 3A, the wiper blade 2 is illustrated in its position not placed against the windshield 4, wherein the lower part 12 is configured in a substantially straight manner. According to yet further embodiments, which can be combined with other embodiments, the lower part 12 is configured in a convex manner in the unloaded state, i.e. with a bulge which projects away from the upper part 10 in a central region. The windshield wiper device according to the embodiments described herein can, upon contact with a windshield 4, starting from the convex shape of the lower part 12, typically then adopt the corresponding concave shape of the lower part 12, which adapts to the windshield 4.

According to a further preferred embodiment, the plurality of connecting elements 18 can be connected to the upper part 10 at a plurality of upper connecting positions and to the lower part 12 at a plurality of lower corresponding connecting positions, wherein, upon the movement of the upper part 10 and of the lower part 12 relative to one another, the spacing between an upper connecting position and a corresponding lower connecting position is substantially constant, in particular constant with a deviation of ±1 mm. As a result, force transmission between the upper part 10 and the lower part 12 can be provided, which allows a windshield wiper device which works in accordance with the fin ray principle.

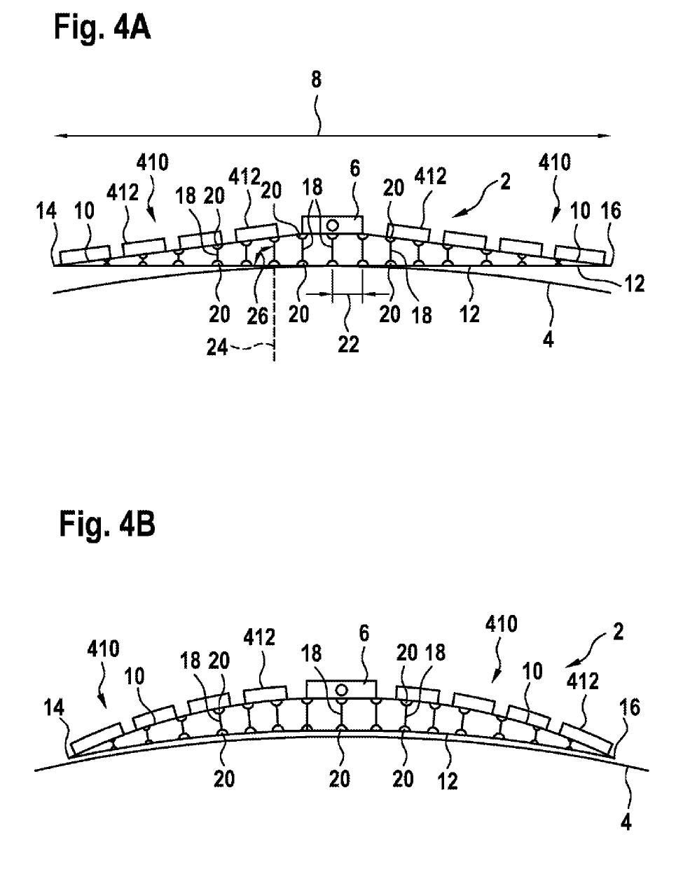

FIG. 4A shows a schematic illustration of a windshield wiper device having the wiper blade 2 according to embodiments of the invention in a basic position. FIG. 4B shows a schematic illustration of the windshield wiper device according to the embodiments of the disclosure according to FIG. 4A in a position placed against a windshield 4.

The windshield wiper device in FIGS. 4A and 4B differs from the windshield wiper device according to FIGS. 3A and 3B by way of the configuration of the spoiler 410.

According to some embodiments, which can be combined with other embodiments described herein, the spoiler 410 has two or more segments 412 which are arranged on the upper part 10 or mounted on or fastened to the latter, such that the spoiler 410 is flexible for example with regard to the longitudinal extent 8. In some embodiments, the two or more segments 412 are arranged in a manner spaced apart from one another. As a result, the spoiler 410 can be flexible, such that the spoiler 410 and the upper part 10 together are flexible and the wiper blade 2 can adapt to the curvature of the windshield 4 of the vehicle.

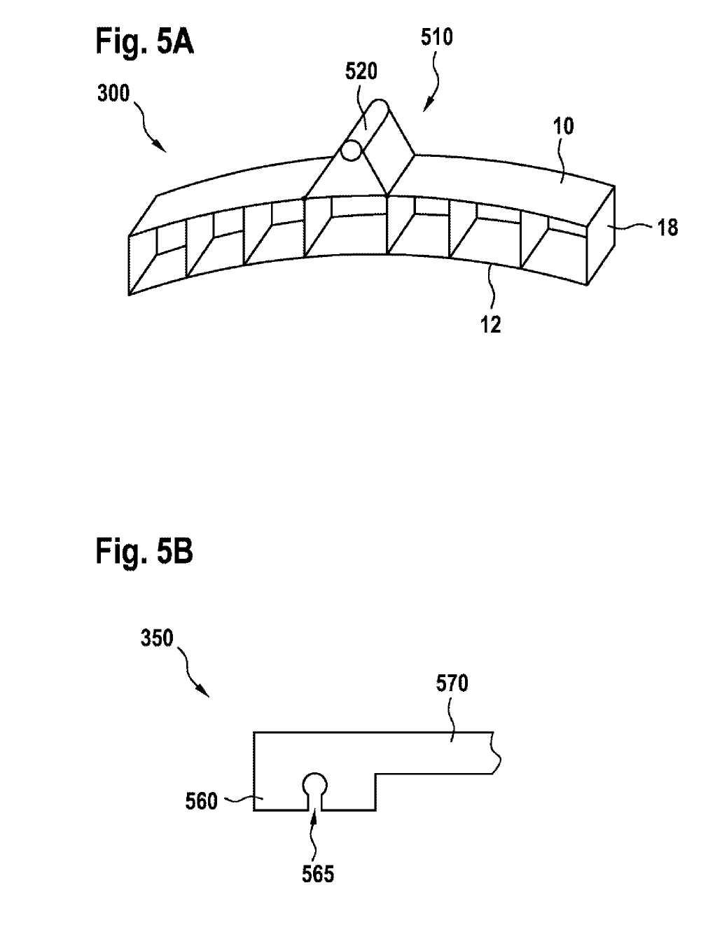

FIG. 5A shows a schematic illustration of a windshield wiper device 300 according to other embodiments of the disclosure. FIG. 5B shows a schematic illustration of an adapter device 350 of the windshield wiper device 300 according to embodiments of the disclosure.

In some embodiments, the windshield wiper device 300 has a wiper-blade-side fastening part 510, which is designed to be connected to a fastening element on the vehicle. According to embodiments, the windshield wiper device 300 comprises an adapter device 350, which is configured as an interface between the wiper-blade-side fastening part 510 and the fastening element on the vehicle. As a result, the windshield wiper device 300 can be mounted easily on differently configured fastening elements, since, in particular, only different adapter devices 350 have to be provided. It is not necessary to adapt the entire windshield wiper device, and in particular the wiper blade, to differently configured fastening elements.

According to one aspect of the present disclosure, an adapter device 350 is specified, which is configured as an adapter or interface between the wiper-blade-side fastening part 510 of the windshield wiper device 300 and the fastening element on the vehicle or a wiper arm 570. The wiper arm 570 can be fastened to the wiper-blade-side fastening part 510. The adapter device 350 is designed to be connected to the wiper-blade-side fastening part 510 of the windshield wiper device 300 and to the fastening element on the vehicle or the wiper arm 570. The fastening element can comprise for example the wiper arm 570. As a result, the windshield wiper device 300 can be mounted easily on differently configured fastening elements or wiper arms.

According to embodiments, the wiper-blade-side fastening part 510 has a first engagement element 520. The adapter device 350 can have a second engagement element 565 which is designed to engage with the first engagement element 520. For example, the first engagement element 520 and the second engagement element 565 can be designed for a force fit and/or form fit. The second engagement element 565 can typically be in the form of a depression or recess, and in particular of a cylindrical depression or cylindrical recess, in an adapter body 560. The first engagement element 520 can have a cylindrical shape which can be inserted with a force fit and/or form fit into the cylindrical depression or the cylindrical recess in the adapter body 560.

According to a further aspect of the present disclosure, a method for producing an above-described windshield wiper device is specified, comprising formation of the spoiler on the upper part by means of injection-molding. As a result, the spoiler can be produced easily and stably. In particular, the spoiler and the upper part can be produced easily with reduced effort.

The windshield wiper device according to the present disclosure can ensure contact of the wiper blade, and in particular of the wiper lip, with the windshield of the vehicle even in the presence of relative wind. In particular, the windshield wiper device according to the present disclosure can ensure a sufficient contact pressure of the wiper blade on the windshield. In this way, a wiping effect can be improved and formation of streaks prevented.

1. A windshield wiper device (100, 200, 300) for a vehicle, comprising a wiper blade (2) having
an elongate upper part (10) which is configured in an at least partially flexible manner,
an elongate lower part (12) which is configured in an at least partially flexible manner,
a plurality of connecting elements (18) for connecting the upper part (10) and the lower part (12), wherein the connecting elements (18) are spaced apart from one another along a longitudinal extent (8) of the wiper blade (2) and are attached to the upper part (10) and/or to the lower part (12) by a rotary joint (20), and
a spoiler (110, 210, 310, 410) which is arranged on the elongate upper part (10).

2. The windshield wiper device (100) as claimed in claim 1, wherein the spoiler (110) has a cross section substantially perpendicular to the longitudinal extent (8) and wherein the cross section is asymmetric.

3. The windshield wiper device (200) as claimed in claim 1, wherein the spoiler (210) has a cross section substantially perpendicular to the longitudinal extent (8) and wherein the cross section is symmetric.

4. The windshield wiper device (100, 200, 300) as claimed in claim 1, wherein the spoiler (110, 210, 310, 410) has a cross section substantially perpendicular to the longitudinal extent (8) and wherein the cross section changes along the longitudinal extent (8).

5. The windshield wiper device (100, 200, 300) as claimed in claim 1, wherein the spoiler (110, 210, 310, 410) extends along at least a part of a length of the wiper blade (2) in the longitudinal extent (8).

6. The windshield wiper device as claimed in claim 1, wherein the spoiler (410) has two or more segments (412) which are arranged on the upper part (10) such that the spoiler (410) is flexible.

7. The windshield wiper device as claimed in claim 6, wherein the two or more segments (412) are arranged in a manner spaced apart from one another.

8. The windshield wiper device (100, 200, 300) as claimed in claim 1, wherein the spoiler (110, 210, 310, 410) is formed from hard plastic.

9. The windshield wiper device (300) as claimed in claim 1, further comprising a wiper-blade-side fastening part (310) configured to be connected to a fastening element on the vehicle.

10. The windshield wiper device (300) as claimed in claim 9, further comprising an adapter device (350) which is configured as an interface between the wiper-blade-side fastening part (310) and the fastening element on the vehicle or a wiper arm.

11. (canceled)

12. A method for producing a windshield wiper device as claimed in claim 1, the method comprising forming the spoiler on the upper part by injection-molding.

13. The windshield wiper device (100) as claimed in claim 1, wherein the connecting elements (18) are configured to allow a movement of the upper part (10) and of the lower part (12) relative to one another with a movement component along the longitudinal extent (8) of the wiper blade (2),

14. The windshield wiper device (100, 200, 300) as claimed in claim 1, wherein the spoiler (110, 210, 310, 410) extends along at least 50% of a length of the wiper blade (2) in the longitudinal extent (8).

15. The windshield wiper device (100, 200, 300) as claimed in claim 1, wherein the spoiler (110, 210, 310, 410) extends along at least 80% of a length of the wiper blade (2) in the longitudinal extent (8).

16. The windshield wiper device (100, 200, 300) as claimed in claim 1, wherein the spoiler (110, 210, 310, 410) extends along at least 100% of a length of the wiper blade (2) in the longitudinal extent (8).

17. The windshield wiper device (100, 200, 300) as claimed in claim 1, wherein the spoiler (110, 210, 310, 410) is formed from thermoplastic or thermosetting plastic.
